(19) United States
(12) Patent Application Publication
(10) Pub. No.: US 2005/0152343 A1
(43) Pub. Date: Jul. 14, 2005

(54) Method and system for providing cellular voice, data and messaging services over IP networks

(76) Inventor: Bala Rajagopalan, Beaverton, OR (US)

Correspondence Address: BALA RAJAGOPALAN, 16364 SW CORNELIAN WAY, BEAVERTON, OR, 97007, US

(21) Appl. No.: 11/031,881

(22) Filed: Jan. 7, 2005

Related U.S. Application Data
(60) Provisional application No. 60/535,137, filed on Jan. 8, 2004.

(51) Int. Cl. H04L 12/66

(52) U.S. Cl. 370/352; 370/401

(57) ABSTRACT

This invention describes a method and system for providing cellular voice, data and messaging services over IP networks. The key components of the system are the Cellular Gateway (CGW), the Cellular Network Adaptor (CNA), and the Subscriber Identity Module (SIM). Whereas the CGW is operated by the cellular service provider or network operator, the CNA and the SIM can be realized in many ways. Using these components, the present invention outlines methods for providing voice and messaging services to cellular subscribers over IP networks

### CROSS REFERENCE TO RELATED APPLICATIONS

Provisional patent application No. 60/535,137 filed on Jan. 8, 2004.

### BACKGROUND OF INVENTION

This invention relates generally to providing cellular voice, data and messaging services over Internet Protocol (IP) networks.

The primary motivation for the present invention is the development of a system for providing an alternate means of delivering cellular services to users over IP networks. Presently, cellular networks suffer from two problems: the rapid increase in the number of users and the resulting lack of spectrum to cover concentrated user populations, and non-uniform quality of cellular coverage within service areas, leading to “holes” in coverage and unpredictable service. The second problem is especially acute inside buildings and other structures which tend to block radio waves. Conventional solutions to these problems involve creating smaller cells to accommodate more users, and providing “hotspot” coverage, i.e., targeted coverage within specific regions such as a building or a small locality. The present invention outlines another, cost-effective method for addressing this problem using IP networks for accessing cellular network services such as voice, data, or messaging, where “messaging” is the generic term used to indicate communication based on short messages, multimedia messages, instant messaging and “push-to-talk” voice communication.

As the popularity of cellular wireless services have increased, so has the penetration of broadband packet networks carrying Internet Protocol (IP) traffic. Presently, economic broadband IP network access is available in residences, dormitories, hotels, airports and other public places over Ethernet, Digital Subscriber Loop (DSL), cable modem, or Wireless Local Area Network (WLAN) technologies. IP networks are being used increasingly to carry not only data traffic but also voice traffic. Thus, the main motivation of the present invention is to enable users with broadband IP network access to receive cellular services through this infrastructure. More precisely, the present invention enables
a voice call or a message destined to a cellular telephone to be delivered to a device attached to an IP network;
a voice call or a message originating from a device attached to an IP network to be identified as a call or a message from a cellular user, and be delivered to a destination cellular device, landline telephone, or IP device (depending on the type of communication and the nature of the destination device);
a device attached to an IP network to originate/terminate data traffic that would normally be originated/terminated by a cellular data terminal;
   The present invention results in two advantages: first, an alternate means of accessing cellular services is made possible in areas where the radio coverage is poor or non-existent. Second, radio spectrum is freed for use by other cellular subscribers.

Another motivation for the present invention is to make it possible for broadband IP network users to have access to cellular services independent of their physical location. For example, a user may be in his residence, his work place, in a hotel room, or at a public “hotspot” (e.g., airport with WLAN access). The present invention makes it possible for the user to access cellular services in any location where broadband IP network connectivity is available. To this end, the present invention introduces the following:
a portable Subscriber Identity Module (SIM) that contains authentication, subscription and other information provisioned by the cellular service provider,
Cellular Network Adapters (CNA) that provide the interworking between non-cellular voice and data terminals, and the cellular network; and
well-defined hardware and software interface in CNAs to accommodate the SIM.
   Under the present invention, the SIM and the CNA can also be realized entirely in software, i.e., as programs running in a computing or communication device.

Yet another motivation for the present invention is to ensure that providing cellular services over IP networks does not require modifications to existing cellular network equipment. To this end, the present invention introduces new entities that interface to existing cellular network equipment transparently, i.e., without requiring any changes to existing equipment.

A further motivation for the present invention is to not require a specific type of voice or data terminal, or a specific access technology when providing cellular services over a broadband IP network. Specifically, the present invention does not rely exclusively on the use of wireless LAN technology and dual-mode handsets (i.e., handsets that communicate using both cellular and wireless LAN radios) for providing cellular services over IP networks. Rather, the usage of multiple types of devices, including dual-mode handsets, over both fixed and wireless packet network access are accommodated.

Yet another motivation for the present invention is to provide unified messaging and notification services to the cellular user reachable over an IP network. These services allow the user to customize the manner in which voice, data and messaging services are integrated. Using these services, for instance,
A user could receive textual notifications delivered to a data terminal (e.g., a personal computer) attached to an IP network when a call destined to his cellular telephone could not be completed;
A voice message left for the cellular telephone number could be delivered by email;
The user's telephone number can be used as a universal identifier to communicate with him through voice, text or multimedia messaging, with delivery to different devices being controlled by the user.

### SUMMARY OF INVENTION

The primary object of the invention is to provide a method and system for delivering cellular voice, data and messaging services over IP networks. The key elements of the system of this invention are:
Cellular Gateway (CGW), an entity which is operated by the cellular service provider and provides the interworking between cellular networks and IP networks;
a Subscriber Identity Module (SIM) that contains authentication, subscription and other information provisioned by the cellular service provider;
Cellular Network Adapters (CNA) that provide the interworking between non-cellular voice and data terminals, and cellular services over IP; and
well-defined hardware and software interface in CNAs to accommodate the SIM.

The CGW is a functional entity that may be realized in several ways. Specifically, it can be realized as a separate programmable, physical device operated by the cellular service provider. Or, CGW functions may be incorporated in an existing programmable device such as a software-based Mobile Switching Center (MSC). In any case, the CGW interacts with the CNA on one side and with existing cellular network elements on the other side. From the cellular network point of view, the CGW looks like another network element that implements compatible communication protocols. Thus, the CGW is able to present users connected to the packet network via the CNA as if these users are directly attached to the cellular network. Further details of the operation of the CGW are described later in the context of the preferred embodiment of the present invention.

The present invention provides for multiple ways to realize the SIM, the CNA and their interaction. This includes the following cases:
The SIM is a physical entity embedded in a card that can be inserted into a standard interface (e.g., compact flash, PCMCIA, etc). In this case, the CNA could be: (1) a physical device with a compatible interface to accommodate one or more SIM cards, or (2) a software program that resides in another device such as a personal computer, a portable handset or a public access telephone that contains a compatible interface to accommodate the SIM card;
The SIM is realized as a software program and/or associated data. In this case, the CNA could be: (1) a physical device that has the SIM functionality built-in with the appropriate user-specific information, or (2) a software program that interacts with the SIM through a well-defined software interface; and
The SIM is a physical or logical entity contained in the portable handset, and the CNA contains a cradle with contact points for interfacing to the handset and accessing the SIM information. When the handset is docked in the cradle, the contact between the CNA and the handset is established, and the SIM information is accessed through the well-defined communication interface.

One possible realization of the primary object of this invention is as follows. Suppose the SIM and CNA are physical entities as described above. The SIM encodes subscription, authentication and other information pertaining to a specific subscriber provisioned by the cellular service provider. The subscriber attaches a voice/data terminal to the CNA and inserts the SIM into the CNA. The CNA reads the subscription information in the SIM and the communicates with a known CGW to establish the presence of the user at a specific IP network address. The CGW, after successfully authenticating the user, registers a user location in the databases of the cellular network. The registered location information is such that any telephone call destined to the number belonging to the user would be directed to the CGW. The CGW then establishes a voice call over the IP network to the CNA, and ultimately to the user's voice terminal. Similarly, a voice call originated from the user's voice terminal is connected via the CNA and the CGW to any cellular or fixed line telephone, or another voice terminal attached to the IP network. Also, specialized features pertaining to voice calls (such as call forwarding, call waiting, conferencing, etc) are implemented by the CGW possibly utilizing other equipment resident in the cellular network.

In addition to voice calls, text, multimedia and push-to-talk messages can be originated/terminated by the user's terminal via the CNA and the CGW. Also, other data and information services offered by the cellular network can be accessed by the user. Further details on the method and the system of the present invention are described later in the context of the preferred embodiment.

Another object of this invention is to deliver cellular services through IP networks to subscribers independent of their physical location. This is accomplished by making both the SIM and the CNA portable. If these are physical entities, then the user carries them from one location to another. The user attaches the CNA to the IP network at each location, attaches the voice or data terminal to the CNA and inserts the SIM in the CNA to access cellular services. The procedure is the same when the SIM is embedded in the CNA. Finally, when the CNA itself is implemented in software, it is executed in a portable device which is attached to the IP network at each physical location.

Yet another object of this invention is to ensure that no modifications are required to existing cellular network equipment. This is accomplished by letting the CGW interface to other cellular network equipment using compatible communication protocols. The CGW thus looks like another cellular network element. Furthermore, the CGW hides the characteristics of the IP network from the cellular network, and in coordination with the CNA, interworks different voice/data terminals to the cellular network transparently.

A further object of the present invention is to make use of different types of voice/data terminals and different IP network access technologies to provide cellular services. This is accomplished under the present invention by separating the functional aspects of SIM and CNA from their physical realization. For instance, by integrating the CNA function within a portable cellular handset, a dual-mode telephone could be used over WLAN access. On the other hand, a separate CNA device can be provided that attaches to a fixed packet network on one side and a variety of voice/data terminals on the other, including ordinary telephones.

Yet another object of the present invention is to provide unified messaging and notification services to a cellular subscriber who is reachable over an IP network. These services allow the subscriber to customize the manner in which voice, data and messaging services are integrated, as described earlier. Under the present invention, these capabilities are realized by suitably programming the CGW. In essence, the CGW controls the manner in which services are delivered to the subscriber over the IP network. Furthermore, the CGW is aware of the IP address and the capabilities of the voice/data terminal used by the subscriber. It can thus support presence-based services such as instant messaging, and unified messaging.

Other objects and advantages of the present invention will become apparent from the following descriptions, taken in connection with the accompanying drawings, wherein, by way of illustration and example, embodiments of the present invention are disclosed.

The invention is not intended to be limited to the embodiments described herein, but is instead intended to include any variations which fall within the scope of the design. The drawings constitute a part of this specification and include an exemplary embodiment of the invention, which may be embodied in various forms. It is to be understood that in some instances various aspects of the invention may be shown exaggerated or enlarged to facilitate an understanding of the invention.

### BRIEF DESCRIPTION OF DRAWINGS

FIG. 1 depicts the components of the system in one embodiment of this invention.

FIG. 2 depicts the components of the cellular network in this embodiment of the invention.

FIG. 3 depicts a realization of the SIM.

FIG. 4 depicts the CNA when realized as a physical device.

FIG. 5 depicts the rear side of the CNA.

FIG. 6 depicts the CNA with a built-in cradle for docking a cellular telephone.

FIG. 7 depicts the registration procedure.

### DETAILED DESCRIPTION

Detailed descriptions of the preferred embodiments are provided herein. It is to be understood, however, that the present invention may be embodied in various forms. Therefore, specific details disclosed herein are not to be interpreted as limiting, but rather as a representative basis for teaching one skilled in the art to employ the present invention in virtually any appropriately detailed system, structure or manner.

While the invention has been described in connection with the preferred embodiments, it is not intended to limit the scope of the invention to the particular form set forth, but on the contrary, it is intended to cover such alternatives, modifications, and equivalents as may be included within the spirit and scope of the invention.

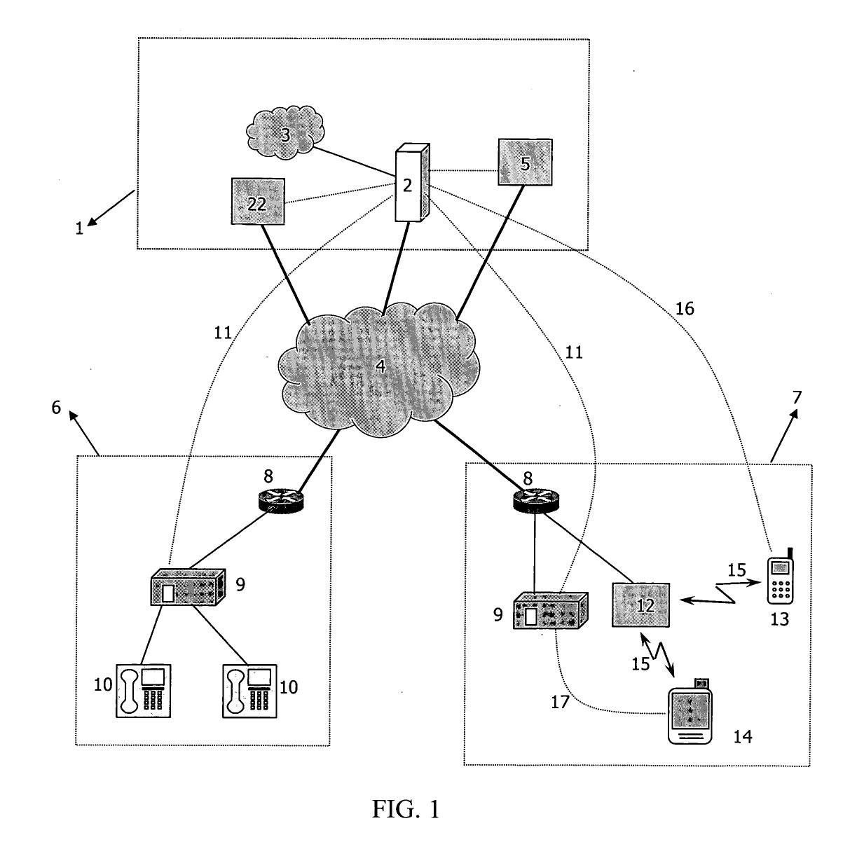

FIG. 1 depicts the components of the system in one embodiment of the invention. Here, the cellular service provider network (1) contains CGW (2), connected to existing cellular network equipment through signaling network (3). In this embodiment, CGW (2) is a separate, physical device. In other embodiments, the CGW functionality may be realized in an existing programmable device such as a software-based MSC. CGW (2) in this embodiment is connected to an IP network (4), which could be a private network or a public network maintained by an Internet Service Provider (ISP). CGW (2) is also connected to Voice over IP (VoIP) equipment (5), which includes media gateway functionality, and multimedia messaging relay (22).

FIG. 1 also depicts two sites (6) and (7) of connected to IP network (4) by IP routers (8). Site (6) contains CNA (9), which is a physical device connected to the IP network (4) via router (8). In another embodiment, the CNA and router functionality may be realized in a single physical device. A multiplicity of (corded or cordless) telephone equipment (10) is connected to CNA (9). CNA (9) interacts with CGW (2) over logical communication interface (11). In site (7), IP access is provided through wireless LAN access point (AP, 12). In another embodiment, the AP and router functionality may be realized in a single physical device. Portable dual-mode handset (13) and Personal Digital Assistant (PDA, 14) attach to IP network (4) using wireless connectivity (15) provided by AP (12). In this embodiment, dual-mode handset (13) contains a physical or logical SIM and a built-in CNA. PDA (14), which does not have built-in SIM, utilizes CNA (9) for receiving cellular services. Handset (13) interacts directly with CGW (2) over the logical communication interface (16), while PDA (14) interacts with CNA (9) using the logical communication interface (17), which in turn utilizes interface (11) to interact with CGW (2). In another embodiment, the CNA and AP functionality may be realized in a single physical device.

Although FIG. 1 depicts a single CGW (2) in the cellular network (1), it is possible in this embodiment of the invention to have multiple CGWs in network (1). Similarly, although FIG. 1 shows CNA (9) communicating with a single CGW (2), it is possible in this embodiment of the invention for CNA (9) to communicate with multiple CGWs in one or more cellular service provider networks. The methods of this invention are applicable in all these cases.

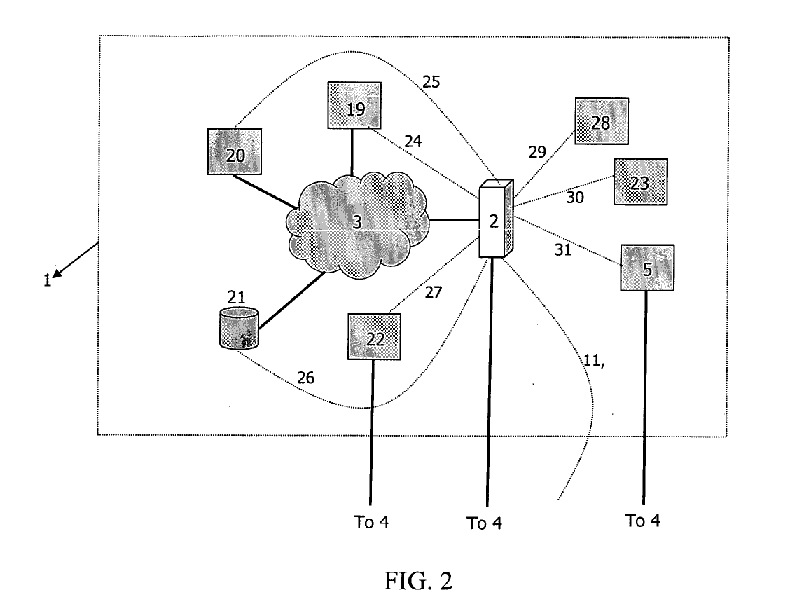

FIG. 2 depicts the key components of cellular network (1) in this embodiment of the invention. For concreteness, this depiction is based on the GSM cellular technology, although the structure will be similar under other cellular technologies. Thus, FIG. 2 depicts MSC (19), the Short Message Service Center (SMSC) (20), the Home Location Register (HLR)/Authentication Center (AuC) (21), and a signaling network (3) to which all these components are connected. In this embodiment, CGW (2) interacts with MSC (19), SMSC (20), and the HLR/AuC (21) using appropriate protocols over the logical interfaces indicated by dotted lines (24-26), respectively, such that CGW (2) resembles another MSC to these entities. CGW (2) also maintains a local data base containing location information (i.e., IP address) pertaining to subscribers accessible over the IP network (similar to the Visitor Location Register, VLR). In the case of GSM, interactions over interfaces (24) and (25) are based on the Mobile Application Part (MAP)-E, and interaction over interface (26) is based on MAP-D. CGW (2) is also connected to a remote Multimedia Messaging Service (MMS) relay (22), and implements the standard MMS_{M} communication interface (27). Finally, CGW (2) connects to a remote management system (28) over logical interface (29), a push-to-talk server (23) over logical interface (30) and VoIP equipment (5) over logical interface (31).

Although FIG. 2 depicts a single MSC (19), CGW (2) may communicate with more than one MSC in network (1), in particular, the Gateway MSC (GMSC) connected to the telephone network. MSC (19) is thus a generic representation for all of them. Also, the functionality provided by VoIP equipment (5) would depend on the functionality present in CGW (2). In the one extreme, CGW (2) may implement all functionality related to signaling and media interworking related to VoIP, obviating the need for VoIP equipment (5). In the other extreme, CGW (2) may implement none of the VoIP functionality, relying entirely on VoIP equipment (5) for all functions. In the current embodiment, CGW (2) implements signaling gateway and media gateway controller functionality, while VoIP equipment (5) is assumed to implement media gateway functionality. This could be different in other embodiments of the present invention.

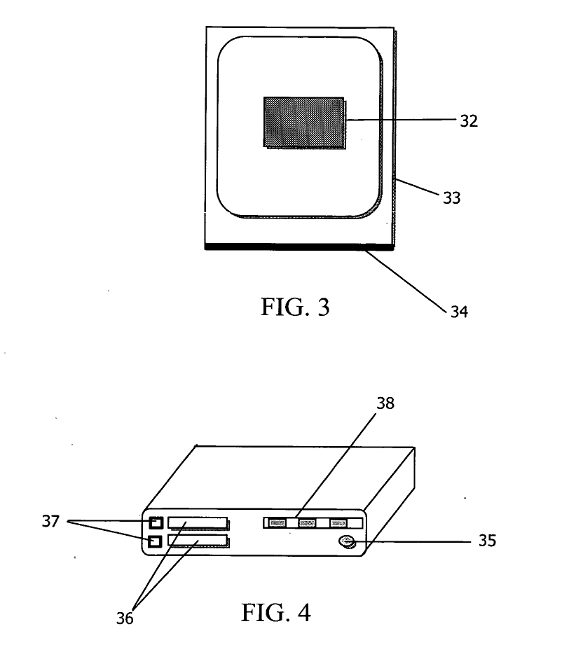

FIG. 3 depicts one embodiment of the SIM, comprising a microchip implementing SIM functionality (32) embedded in a compact card (33) with an electrical interface (34). Interface (34) could be a PCMCIA, Secure Digital (SD), compact flash, or other standard or proprietary interface.

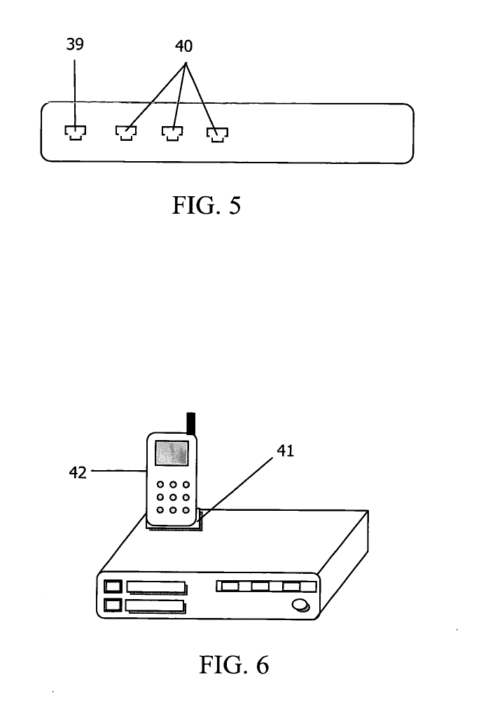

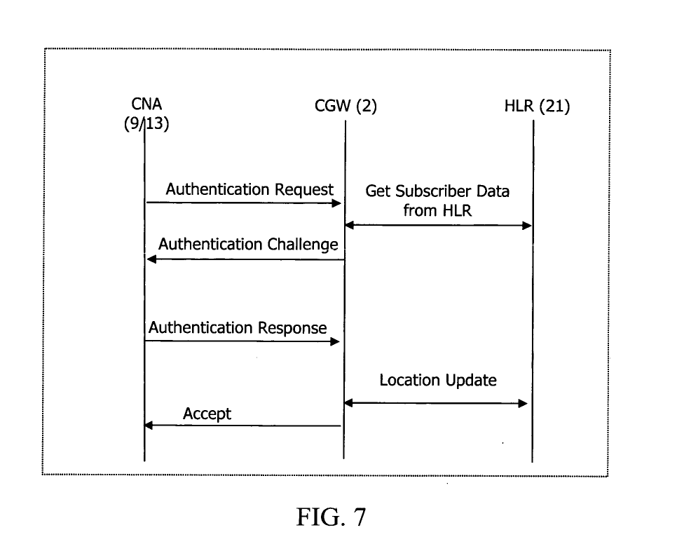

FIG. 4 depicts one embodiment of the CNA as a physical device, comprising a power switch (35), multiplicity of slots (36) for inserting SIM cards and associated activate/deactivate buttons (37), and LED status indicators (38). Slots (36) contain electrical interfaces compatible with the SIM. FIG. 6 depicts the rear of the CNA, comprising an Ethernet jack (39) and a multiplicity of telephone jacks (40). In this embodiment, the CNA is connected to the IP network using Ethernet jack (39) and corded or cordless telephones using jacks (40). FIG. 5 depicts another embodiment of the CNA wherein a cradle (41) is used to interface to portable handsets (42). Cradle (41) may also provide battery charging functionality in addition to interfacing to the subscriber information contained in the handset. In another embodiment, the subscriber information may be programmed in the CNA, thereby obviating the need to insert a physical SIM. In yet another embodiment, the CNA may be directly connected to the residential telephone wiring thereby allowing the use of wall telephone jacks already installed. Also, in other embodiments, the CNA functionality may be combined with a wireless LAN AP or router in a single physical device.

In this embodiment of the invention, user equipment such as dual-mode handsets have the CNA functionality realized internally. A physical CNA, as depicted in FIG. 4, is not needed when using such equipment. Whether logical or physical, the CNA functionality includes the following:
Ability to read SIM information under different SIM realizations;
Registration and deregistration of the subscriber identity and associated IP address information with the cellular gateway;
Conversion of analog voice signals to IP packets as per one or more coding schemes and vice versa;
Implementation of the control plane for voice, text and multimedia messaging, push-to-talk and data access services over IP;
Keeping records on voice and messaging usage and associated properties; and
Providing directory functions.
   Additionally, a physical CNA device also provides for the interworking of analog telephone equipment with VoIP.

The delivery of cellular services over IP is activated in the following manner. If the CNA is realized as a physical entity, the user inserts a SIM card in one of the slots (36) and pushes the associated activation button. More than one user may activate cellular services this way. If the CNA has a built-in cradle (41), the user may also place his handset in the cradle to activate the service. If the CNA is realized as a software program, an appropriate user interface allows the user to activate services. Other than when a cradle is used, the user is required to turn his cellular telephone off before activating the service over IP. With a dual-mode handset, the CNA functionality may be invoked automatically when wireless LAN signal is detected. This will lead to automatic service activation.

When service is activated, the CNA initiates a registration procedure with the appropriate CGW. The IP address of the CGW is obtained either from the SIM or from a well-known server whose IP address is configured in the CNA. The following description of the procedure, which is just one possibility, is given with reference to FIGS. 1 and 2 where physical CNA (9), or internal CNA function in (13) interacts with CGW (2). FIG. 7 depicts the sequence of messages between various entities involved in the procedure. These messages flow over interface (11) between CNA (9) and CGW (2) (or interface (16) between internal CNA in (13) and CGW (2)), and interface (26) between CGW (2) and HLR (21).

As depicted in FIG. 7, CNA (9 or 13) sends an “Authentication Request” message with the subscriber identification, its own IP address and other relevant information. CGW (2) in turn contacts HLR (21) to obtain subscriber information, including authentication challenge and response tuples. It then sends an authentication challenge to CNA (9 or 13). Using the embedded SIM or configured authentication key, CNA (9 or 13) computes a response and sends it back to CGW (2), which updates its local database with the IP address of the CNA. CGW (2) also updates HLR (21) with location information that points to itself for receiving all incoming voice calls/messages destined to the subscriber. It then sends an “Accept” message to CNA (9 or 13), which completes the registration procedure.

Certain user equipment utilizing wireless interface (15) may not have an embedded SIM, even though they have other CNA functions and thus are capable of receiving cellular services over IP. PDA (14) in FIG. 1 is an example of this. To accommodate these types of equipment, the present invention incorporates a “proxy” capability in the CNA. Briefly, with this capability, physical CNA (9) performs the registration function (as depicted in FIG. 7) on behalf of user equipment (14), and remains as an intermediary during subsequent cellular service delivery to the user equipment. The activation of registration in this case is initiated using the communication protocol (17) between user equipment (14) and physical CNA (9). This protocol may incorporate additional security procedures to ensure that only valid users and devices are able to access the CNA. The present invention thus allows a cellular subscriber to use any device with the appropriate capabilities to access cellular services without the need for the service provider to provision the device.

The descriptions above have been simplified to illustrate the general principles involved rather than specifying the actual protocols used or other capabilities possible under different embodiments of the present invention. For instance, the authentication procedure may result in the distribution or derivation of encryption keys for protecting the data transiting wireless interface (15). Also, all the messages between the CNA and the CGW may be encrypted. Finally, the procedure above may not complete under different error conditions, which have not been considered for reasons of simplicity.

Once a subscriber is registered, incoming voice calls dialed to his cellular telephone number are routed as follows. With reference to FIGS. 1 and 2, signaling related to such calls are received by GMSC (19) or another MSC (19) in the cellular service provider network (1). GMSC or MSC (19) looks up HLR (21), which has the registration information pointing to CGW (2) as the visiting MSC (CGW (2) contains the VLR functionality, as described earlier). HLR (21) then provides CGW (2) with the identity of the subscriber and queries for a routing number. CGW (2) supplies an appropriate number that results in the signaling messages related to the call set up being routed to itself. CGW (2) determines the previously registered IP address of the subscriber equipment from its local database. This could be a physical CNA (9) or logical CNA function in (13). It then signals to CNA (9 or 13) an incoming voice call destined to the identified subscriber, along with other pertinent information. CNA (9 or 13) in turn alerts the user terminal, for instance, by generating the ring tone in telephone (10) or sending a message over interface (17). After receiving the appropriate response from the user terminal, CNA (9 or 13) sends a response to CGW (2). The latter then establishes the data path between VoIP equipment (5) and CNA (9 or 13) by suitably commanding VoIP equipment (5) and CNA (9 or 13) and completing the signaling on the cellular network side. CNA (9) completes the data path using either the direct physical interface to (10) or communication interface (17) to (14).

Voice calls dialed by the user to an external destination is processed as follows. Considering FIGS. 1 and 2, user enters the destination number in his device, (10), (13) or (14). In the case of telephone (10), the direct physical interface is used to signal the dialed number to CNA (9). In the case of PDA (14), communication interface (17) is used to signal the dialed number to CNA (9). CNA (9 or 13) signals CGW (2) to establish the call. CGW (2) performs functions similar to the description above to complete the signaling and establish the data path.

Incoming short messages, multimedia messages, and push-to-talk voice are delivered to the user using message flow sequence similar to that described for voice calls with the following exceptions. For short messages, CGW (2) interacts with SMSC (20) in addition to HLR (21). For multimedia messaging and push-to-talk voice, CGW (2) interacts with MMS relay (22) and push-to-talk server (23), respectively. Furthermore, the messaging data is carried directly between CGW (2), and CNA (9 or 13) without involving VoIP equipment (5). CNA (9) makes use of communication interface (17) to deliver messages to device (14). It is to be noted that the specific services that may be delivered will depend on the capabilities of the user equipment.

Short messages, multimedia messages, and push-to-talk voice spurts destined for external destinations from the user are signaled in the reverse sequence, i.e., from the user equipment to the CNA, from the CNA to the CGW and then to SMSC, MMS relay or push-to-talk server. The associated data is carried directly between these entities.

A user is deregistered from the CGW under the following conditions. First, the user may explicitly or implicitly invoke signaling to deregister. Implicit deregistration occurs, for instance, when the user equipment (13, 14) or CNA (9) is powered off. Explicit deregistration occurs when the activate/deactivate button (37) (FIG. 4) is pressed, or a deactivation command is issued through communication interface (17) (when the CNA is providing proxy service for wireless equipment). Considering FIG. 1, deregistering involves signaling from CNA (9 or 13) to CGW (2), which signals to HLR (21) to remove the user's location information. CGW (2) then removes the user's location information from its own database, and signals to CNA (9 or 13). The process completes when CNA (9 or 13) sends an indication to the user. When CNA (9) acts as a proxy, the indication to the user utilizes communication interface (17). CGW (2) may invoke the authentication procedure shown in FIG. 7 during deregistration. Second, automatic deregistering occurs when the user moves from the IP network and attaches to the cellular network. This may happen in two ways: when dual-mode handset (13) is used, it will automatically attach to the cellular network when the user is beyond the range of the wireless IP network. The other possibility is that a user turns on his cellular telephone, which attaches to the cellular network. In both these cases, HLR (21) is updated with new location information. It then commands CGW (2) to remove the previous location information pertaining to the subscriber. If a physical CNA (9) is used, CGW (2) then signals CNA (9) about the deregistration of the user. Finally, deregistering also occurs when user equipment (10/13/14) cannot be reached during normal signaling communication. The procedure in this case is similar to the first case, except the user equipment is not involved. Once a subscriber is deregistered, the registration procedure must be executed again before the subscriber can receive services.

A CGW in this embodiment of the invention can support direct communication between subscribers known to be present under different CNAs, as registered in its local data base. Specifically, when a voice call or messaging related signaling is received from a CNA, the CGW can determine if the destination subscriber is reachable under another CNA. In this case, the CGW need not involve any cellular network elements to complete the signaling and establish the data path directly between the source and destination user equipment.

Being fully involved in the signaling of voice and messaging services, CGW (2) in this embodiment of the invention can provide statistics on service usage for billing and other purposes. Similarly, CNA (9 or 13) can keep track of various statistics on voice and message traffic passing through it. Additionally, CNA (9 or 13) can provide directory services (e.g., names and phone numbers) to users, either coordinating with another server (e.g., a personal computer) or using local storage of such information.

Finally, the CNA and the CGW cooperate to enable the provisioning of directly billed data services to cellular subscribers. Such services include downloading ring tones, games or other applications that are charged to the subscriber's account. Provisioning such services require that the subscriber to be identified reliably and data to be delivered only to the subscriber being billed. These services are typically available from servers in the cellular service provider's network. In this embodiment of the invention, traffic to servers in the service provider's network from the subscriber equipment is securely tunneled between the CNA and the CGW. Similarly, traffic from the servers is sent via the CGW and tunneled to the CNA. Several protocol options exist for such secure tunneling, and it is possible for the CGW to reliably identify the subscriber with any of these methods. The data services, however, are available only to user equipment provisioned by the service provider, such as dual-mode phones.

1. A system for enabling
a voice call or a message destined to a cellular telephone to be delivered to a device attached to an Internet Protocol (IP) network;
a voice call or a message originating from a device attached to an IP network to be identified as a call or a message from a cellular user, and be delivered to a destination cellular device, landline telephone, or IP device; and
a device attached to an IP network to originate/terminate data traffic that would normally be originated/terminated by a cellular data terminal,
wherein the system comprises
At least one programmable device called cellular gateway that is connected to the cellular network through standard signaling interfaces, resembles a cellular network element when communicating with legacy cellular network devices, and maintains, among other information, a database of cellular subscriber identities and corresponding IP address information;
A plurality of functional entities called Subscriber Identity Modules (SIMs) each of which contains authentication, subscription and other information provisioned by the cellular service provider for a specific user;
A plurality of functional entities called cellular network adapters (CNAs), either physically distinct or contained as part of a communication device, each of which is connected to an IP network, provides interfaces for one or more SIM entities, and provides the interworking between the cellular gateway and non-cellular voice and data terminals;
A plurality of voice-over-IP media gateways connected to cellular network elements to convert circuit-switched voice to voice-over-IP, and vice versa;
A management system, which is used to provision and manage services through the cellular gateway;
An IP communication link between the cellular gateway and each CNA to transport signaling and data messages;
An IP communication link between the cellular gateway and each voice-over-IP media gateway to transport signaling messages;
An IP communication link between each CNA and each voice-over-IP media gateway to transport IP packets carrying voice;
An IP communication link between the management system, and the cellular gateway it controls; and
Voice and data communication devices (user equipment) with software that allow them to communicate with a CNA over an IP network.

2. The system of claim 1, wherein a cellular subscriber connected to an IP network is recognized in the cellular network by a method comprising
Identification of the cellular subscriber information from a SIM, and the IP address of the subscriber's device, by a CNA;
The CNA registering the subscriber information along with an IP network address with the cellular gateway;
The cellular gateway acting as an intermediary to translate cellular network authentication and location update protocol messages into a form recognizable by the CNA, and similarly translating the responses back; and
The cellular gateway registering location information corresponding to the subscriber in the appropriate databases of the cellular network in such a manner that signaling pertaining to voice and messaging that is destined to the subscriber would be directed to the cellular gateway;

3. The system of claim 1, wherein a communication device with both cellular and wireless local area network radios, and a built-in CNA and SIM functions automatically connects to an IP network by a method comprising
Detecting the wireless link to the IP network by either automatic or user-initiated monitoring of wireless local area network control messages;
Registering with a cellular gateway using the built-in CNA function; and
Completing the location update function.

4. The system of claim 1, wherein a voice call or information message targeted at a subscriber attached to an IP network and initiated from the public cellular or telephone network is accomplished by a method comprising,
Routing the voice signaling or information message to the cellular gateway from within the cellular network, using previously registered location information;
Using the subscriber identification in the voice signaling or information message by the cellular gateway to identity the corresponding IP address registered by the CNA under which the subscriber is attached;
Translation of the voice signaling or information message by the cellular gateway into a protocol recognizable by the CNA, and communication of this to the CAN over the IP link;
Using the subscriber identification in the voice signaling or information message by the CNA to identify the local port or the IP address to which the message should be sent to reach the subscriber's device;
Delivering the voice signaling or information message to the subscriber's device by the CNA in the appropriate manner depending on the nature of the device;
Delivering the response from the subscriber's device to the cellular gateway by the CNA using the appropriate protocol;
Signaling a media gateway, if necessary, by the cellular gateway to establish a bearer path to the CNA; and
Establishing the bearer path from the CNA to the subscriber's device.

5. The system of claim 1, wherein a voice call or messaging communication initiated by a subscriber's device attached to an IP network is completed by a method comprising,
Routing the voice signaling or information message from the subscriber's device to a CAN using a communication protocol;
Modification of the received voice signaling or information message by the CNA into a form recognized by the cellular gateway if necessary, and routing of the modified voice signaling or information message to the cellular gateway by the CNA;
If the destination is present under another CNA, routing of the voice signaling or information message to the other CNA by the cellular gateway, completion of the voice signaling in the reverse direction, and commencement of the voice or information exchange between the source and destination devices via the two CNAs;
If the destination is external to the IP network, translation of the voice signaling or information message by the cellular gateway into a protocol message used within the cellular network, delivery of it to an appropriate cellular network element, completion of the signaling in the reverse direction, and establishment of the bearer path between the source and destination devices via a media gateway (in case of voice call.

6. The system of claim 1, wherein the cellular gateway further comprises a programmable software system and hardware interfaces which allows the implementation of various functions in conjunction with the CNA such as voice-related supplementary services, unified messaging, data and personal information synchronization, and interfacing to other cellular voice and messaging systems.

7. The system of claim 1, wherein a secure IP tunnel is implemented between the cellular gateway and the CNA to transfer data and signaling messages, specifically separately billed data.
